(19) United States
(12) Patent Application Publication
(10) Pub. No.: US 2022/0410708 A1
(43) Pub. Date: Dec. 29, 2022

(54) METHOD AND SYSTEM FOR ADAPTIVELY PROCESSING VEHICLE INFORMATION

(71) Applicant: WIESS CORPORATION, Taipei City (TW)

(72) Inventor: HUNG-YUAN HUNG, Taipei City (TW)

(73) Assignee: WIESS CORPORATION, Taipei City (TW)

(21) Appl. No.: 17/686,602

(22) Filed: Mar. 4, 2022

(30) Foreign Application Priority Data
Jun. 29, 2021 (TW) 110123852

(51) Int. Cl. B60K 35/00

(52) U.S. Cl. CPC B60K 35/00; B60K 2370/178; B60K 2370/186; B60K 2370/158; B60K 2370/157; B60K 2370/152

(57) ABSTRACT

This invention provides a method for adaptively processing car information. The method includes: receiving a first car information, identifying system function(s) thereof, and analyzing all system malfunctions thereof; receiving a second car information; determining a relation between the system malfunctions and the second car information at a relative predetermined safe threshold; setting a severity level, an exposure level, and a controllability level for a hazard event based on a predetermined standard when the safe threshold is gone beyond; and classifying the first car information to a safe level according to the severity level, the exposure level, and the controllability level.

### BACKGROUND OF THE INVENTION

### 1. Field of the Invention

The present invention relates to the field of vehicle information processing method and system thereof, more particularly, to a multiple interface of intuitive sensory feedback for processing vehicle information, it is the method and system for adaptively processing vehicle information using real-time vehicle information through a realistic accident simulation operation.

### 2. Description of the Prior Art

In modern days, automobiles are equipped with many electronic control units (ECUs) for their subsystems, so as to receive feedback information from their corresponding sensors and/or control their corresponding drivers. Common controllers are engine controllers, in addition, transmission, airbags, anti-lock braking system (Anti-lock Braking System; ABS), cruise control, power steering, audio system, power windows, doors, Mirror adjustment, charging systems for batteries and hybrid electric vehicles, . . . etc. all of them use electronic controllers. Among these electronic controllers, some are independent subsystems, and some need to communicate with other subsystems to complete the desired operations, and display relevant processing information on the vehicle dashboard to notify the driver, allowing the vehicle driver to take the appropriate action.

However, the traditional analog dashboard has long been overloaded with the huge amount of information and the accuracy of the displayed information needs to be improved, the replacement is the digital dashboard. Compared with the traditional analog dashboard, the digital dashboard is able to integrate multimedia information and basic vehicle information to display on the instrument panel (digital screen) more rationally and precisely. Through digitization, it is able to simulate traditional dashboard, and can also display global positioning system (Global Positioning System; GPS) navigation information , multimedia music play list, communication list, comprehensive travel information, information of oil temperature and voltage, and many other information

In addition, the vehicle dashboard is the major component monitoring the safety of the vehicle during driving, therefore, human-computer interaction is very important. Thus, the design of hardware and software of the interface must deliver the convenience, rationality and controllability. When vehicle information being diversified and scattered, in addition to more system information such as On-Board Diagnostics (OBD), Advanced Driver Assistance System (ADAS), etc., this will not only make the displayed information messy and easily make the driver's senses overloaded. In other words, the driver cannot effectively determine the importance of the vehicle information in a short time and take appropriate actions, which will seriously affect the safety of driving.

Therefore, it is one of the methods to help the driver to judge the importance of the vehicle information in a short time by effectively classifying the complex vehicle information un term of safety. Because vehicle information (for example: vehicle speed, tire pressure, . . . and other information) change continuously during the driving, so the influence of these vehicle information variables on other vehicle information in the aspect of classification of safety levels should be adaptively processed and adjusted to provides the driver with more accurate driving information with respect to the safety.

Therefore, the present invention provides a vehicle dashboard system having an intuitive human-computer interaction interface. The multi-sensory interface provides differentiated intuitive sensory feedback according to the safety level of the vehicle information, so that the driver is able to make judgement in a short time, knowing the importance of vehicle information, and take appropriate actions; and the present invention provides an intuitive human-computer interaction platform by executing a realistic accident simulation, so that the vehicle information can still be accurately, under the influence of other real-time vehicle information variables, to determine the safety level and to provide the driver with reference of driving.

### SUMMARY OF THE INVENTION

According to a preferred embodiment of the present invention, an adaptive vehicle information processing method is provided, comprising: receiving a first vehicle information, identifying the function of the first vehicle information and analyzing all functional failures of the first vehicle information; receiving a second vehicle information; determine the relationship between all the above-mentioned functional failures and the second vehicle information corresponding to a preset safety threshold; when the safety threshold is exceeded, set up a severity of the hazardous event according to a predetermined standard, exposure rate and controllability level; and according to the severity, exposure rate and controllability level of the hazard event, to classify the safety level of the first vehicle information

In this embodiment, it further includes checking the format of the first vehicle information, wherein when the format of the first vehicle information is not correct, and the error is still after rechecking is performed for a specified number of times, the first vehicle information is ignored

In one embodiment, when the format of the first vehicle information is correct, the parsing of the first vehicle information includes normal information

In one embodiment, when the format of the first vehicle information is correct, the parsing of the first vehicle information includes warning information

In this embodiment, the second vehicle information includes at least one information other than the first vehicle information.

In this embodiment, the severity of the described hazardous event includes: none; mild/moderate; severe; and fatal injury level.

In this embodiment, the exposure rate of the hazardous event includes: ultra-low probability; low probability; medium probability; and high probability.

In this embodiment, the controllability of the hazardous event includes: full controllability; simple controllability; regular controllability; and difficult controllability.

In this embodiment, the safety level includes: from top to low, level one; level two; level three and level four.

In this embodiment, when the safety level not exceeding the preset safety threshold, classify the first vehicle information the safety level.

According to another preferred embodiment of the present invention, an adaptive vehicle information processing system is provided, comprising: a chip system for receiving a first vehicle information, identifying the function of the first vehicle information and analyzing all functional failures of the first vehicle information; receiving a second vehicle information; determine the relationship between all the above-mentioned functional failures and the second vehicle information corresponding to a preset safety threshold; when the safety threshold is exceeded, set up a severity of the hazardous event according to a predetermined standard, exposure rate and controllability level; and according to the severity, exposure rate and controllability level of the hazard event, to classify the safety level of the first vehicle information.

In this embodiment, the chip system further check the format of the first vehicle information, wherein when the format of the first vehicle information is not correct, and the error is still after rechecking is performed for a specified number of times, the first vehicle information is ignored.

In one embodiment, when the format of the first vehicle information is correct, the chip system parses the first vehicle information including normal information.

In one embodiment, when the format of the first vehicle information is correct, the chip system parses the first vehicle information including warning information.

In this embodiment, the second vehicle information includes at least one information other than the first vehicle information.

In this embodiment, the severity of the described hazardous event includes: none; mild/moderate; severe; and fatal injury level.

In this embodiment, the exposure rate of the hazardous event includes: ultra-low probability; low probability; medium probability and high probability

In this embodiment, the controllability of the hazardous event includes: full controllability; simple controllability; regular controllability; and difficult controllability

In this embodiment, the safety level includes: from top to low, level one; level two; level three and level four.

In this embodiment, when the safety level not exceeding the preset safety threshold, classify the first vehicle information the safety level.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram of a preferred embodiment of the present invention.

FIG. 2 is a flow chart of a preferred embodiment of the present invention

FIG. 3 is a flow chart of another preferred embodiment of the present invention.

### DETAILED DESCRIPTION OF THE PREFERRED EMBODIMENTS

Some embodiments of the present invention are described in detail below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

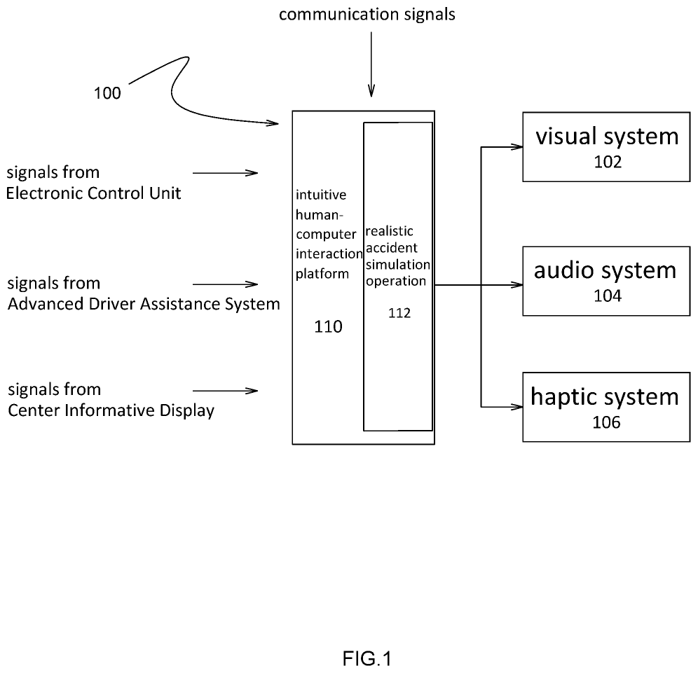

Please refer to FIG. 1, which is a schematic diagram 100 of a preferred embodiment of the present invention. In FIG. 1, an intuitive human-computer interaction platform 110 receives at least one or a plurality of signals from Electronic Control Unit (ECU), Advanced Driver Assistance System(ADAS), Center Informative Display(CID), and so forth, wherein, the signal(s) from ECU may be one single or multiple vehicle information generated by a single ECU, or may be multiple vehicle information generated by multiple ECUs, meanwhile, the signal(s) may be a single one or multiple ones transmitted simultaneously or sequentially to the intuitive human-computer interaction platform 110, but the scenario herein is not the limitations of the present invention. In one embodiment of the present invention, the intuitive human-computer interaction platform 110 is a platform that may include a chip system.

After the intuitive human-computer interaction platform 110 received the signals, the vehicle information represented by these signals will be classified on the safety level through a realistic accident simulation operation 112. After the intuitive human-computer interaction platform 110 determines the security level of these signals, the intuitive human-computer interaction platform 110 drives a visual system 102, an audio system 104 and a haptic system 106 to perform multi-interface differential intuitive sensory feedback operation according to the determined level, thereby providing drivers with different levels of intuitive sensory feedback in visual, auditory and tactile aspects.

In one embodiment of the present invention, the visual system 102 may comprises a Head-Up Display (HUD), the HUD performs difference feedback operations, including low brightness on, low brightness flickering, high brightness flickering and high brightness fast flickering, and in another embodiment of the present invention, the visual system 102 may comprises a LCD display screen, the LCD display screen performs difference feedback operations, including low brightness on, low brightness flickering, high brightness flickering and high brightness fast flickering, to provide the driver the different level of intuitive sensory feedback in visual aspect. In one embodiment of the present invention, the brightness of the background of the visual system 102, or the responding icon of the vehicle information showing on the visual system 102, can be adjusted to perform difference feedback operations, but it's not the limitation of the present invention.

In one embodiment of the present invention, the audio system 104 comprises a car audio, the car audio performs difference feedback operations, including no action, low reminding sound, high short reminding sound, and high short fast reminding sound, and in another embodiment of the present invention, the car audio performs difference feedback operations, including human voice and /or computer voice reminding operations, to provide the driver the different level of intuitive sensory feedback in audio aspect.

In one embodiment of the present invention, the haptic system 106 comprises a center informative display that performs difference feedback operations, including no action, short vibration, constant short vibrations, and constant long vibrations, to provide the driver the different level of intuitive sensory feedback in haptic aspect.

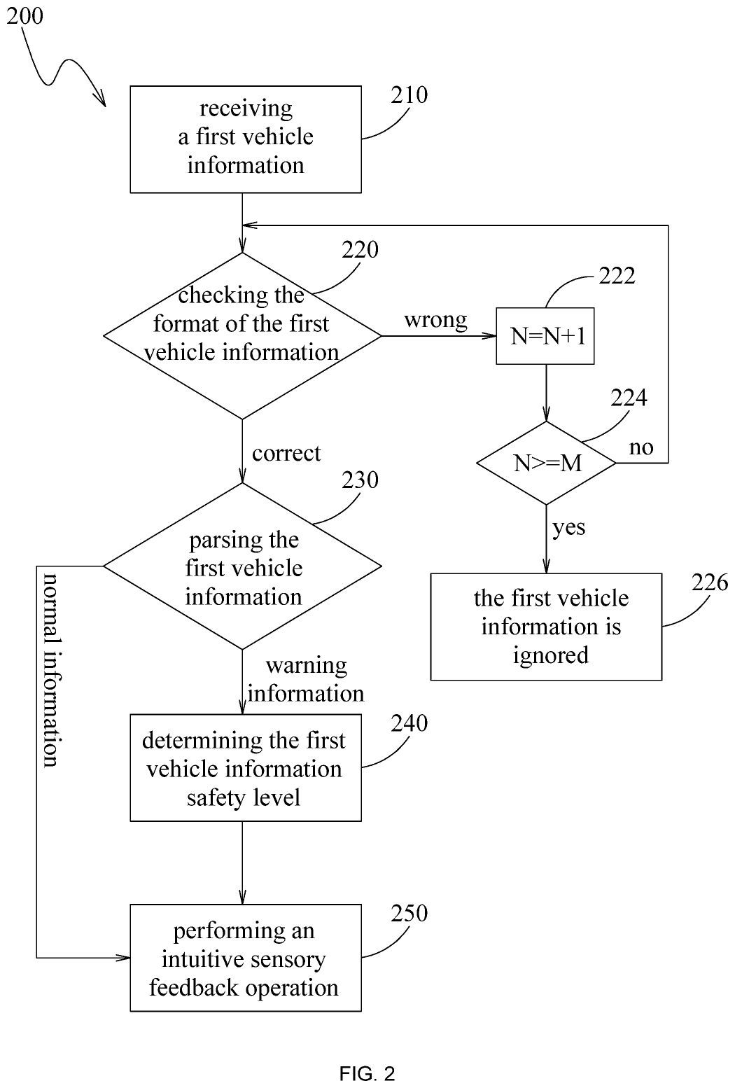

Please refer to FIG. 2, which is a flow chart 200 of one preferred embodiment according to the present invention. In FIG. 2, in step 210 the intuitive human-computer interaction platform 110 (referring the chip system 212 FIG. 1) receives at least one or a plurality of signals from one ECU(Electronic Control Unit) or multiple ECUs (ECU 1˜ECU N, N is integer), signals from an Advanced Driver Assistance System(ADAS) 230, signals from a Center Informative Display(CID) and/or signals from multiple communication channels, the signal(s) may be transmitted to the chip system via one of the following protocols or their combination, including Universal Asynchronous Receiver/Transmitter (UART), Controller Area Network (CAN), On-Board Diagnostics (OBD), Bluetooth, GPS and 5 G communication, but the scenario herein is not the limitations of the present invention.

In steps 220, 222, 224 and 226, the system chip checks the format of the first vehicle information, wherein when the format of the first vehicle information is incorrect, if the re-check is performed for a specified number of times in steps 222 , 224 and 220 and the error still exists, then the first vehicle information is ignored, as in step 226. In other words, format errors caused by data generation or transmission are excluded, therefore, when an error occurs in the check in step 220, the first vehicle information format is sent to step 220 for rechecking through the settings in steps 222 and 224, wherein N is a natural number with an initial value of 0, and M is a natural number with a specified number of times.

In step 230, the system chip parses the first vehicle information. When the first vehicle information is a normal message, step 250 is performed to perform an intuitive sensory feedback operation; when the first vehicle information is a warning message, step 240 is performed. In step 240, the system chip performs a realistic accident simulation operation to determine the first vehicle information safety level. After the safety level is classified, step 250 is executed to perform an intuitive sensory feedback operation, that is, the system chip is based on the determined classification to drive the above-mentioned visual system, auditory system and haptic system to perform multi-interface differentiated intuitive sensory feedback operation, thereby providing the vehicle driver with intuitive sensory feedback in different degrees of vision, hearing and touch aspect.

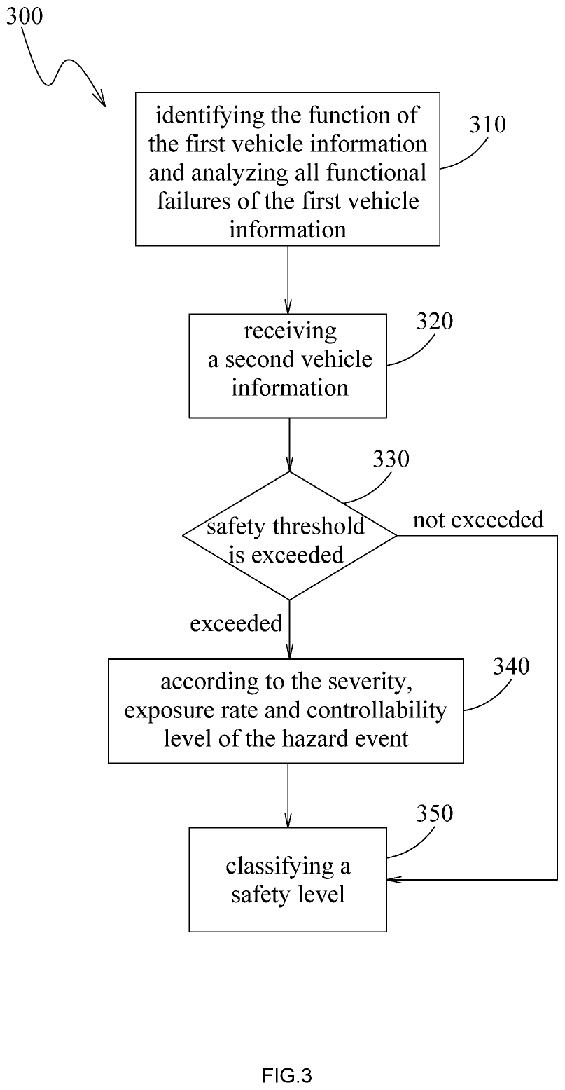

Please refer to FIG. 3, which is a flowchart 300 of a preferred embodiment of the present invention, In the present invention, steps 310-350 may be regarded as a preferred implementation step of step 240 shown in FIG. 2, but are not intended to limit the implementation of the present invention. In step 310, the system chip identifies the function corresponding to the first vehicle information (fix examples, the function of suspension system, braking system, anti-collision system, etc.) and analyzes all functional failures of the first vehicle information. In step 320, the system chip receives a second body information, wherein the second body information includes at least one vehicle information other than the first body information.

In step 330, the system chip determines the relationship between all the functional failures of the first vehicle information and the second vehicle information at a corresponding preset safety threshold. For example, a functional failure will only cause casualties under certain circumstances. For example, one of the functional failures of the car light system is the unexpected damage of the bulb. If other vehicle information shows that the vehicle is driving on a dark mountain road, this functional failure exceeds one of its corresponding preset safety thresholds; if other vehicle information shows that the vehicle is driving on a flat road during the day, this function failure does not exceed its corresponding preset safety threshold. Another example: one of the functional failures of the braking system is the unexpected damage of the brakes. If other vehicle information shows that the vehicle is driving at a speed of 100 km/h, this functional failure exceeds a corresponding preset safety threshold; if other vehicle information shows that the vehicle is in parking status, then this function failure does not exceed its corresponding preset safety threshold.

Therefore, when it is determined in step 330 that the functional failure does not exceed the safety threshold, step 350 is executed to classify a safety level relative to the first vehicle information. When it is determined in step 330 that the functional failure exceeds the safety threshold, in step 340, the chip system sets the severity, exposure rate and controllability level of a hazardous event according to a predetermined standard, wherein the predetermined standard is shown in the following Table 1. Among them, the severity (severity) refers to the degree of injury to the driver, passengers or pedestrians and other persons involved in danger; the exposure rate (exposure) refers to the probability that personnel are exposed to the scene where the system failure can cause harm; controllability (controllability) refers to the possibility that a driver or other person at risk can avoid an accident or injury

TABLE 1

| severity | | exposure rate | | controllability | |
|---|---|---|---|---|---|
| S0 | none | E1 | ultra-low | C0 | full |
| S1 | mild/moderate | E2 | low | C1 | simple |
| | | | (1%) | | (>99% of drivers) |
| S2 | severe | E3 | medium | C2 | regular |
| | | | (1~10%) | | (>90% of drivers) |
| S3 | fatal injury | E4 | High | C3 | difficult |
| | | | (>10%) | | (<90% of drivers) |

In step 350, the system chip classifies the first vehicle body information as a security level according to the severity, exposure rate and controllability level of the hazard event as shown in Table 2. Among them, the quality management of QM meter does not involve the setting of safety level. The security level includes at least the first levet the second level; the third level; and the fourth level according to the level from low to high.

TABLE 2

| | |
|---|---|
| exposure | controllability |

| severity | rate | C1 | C2 | C3 |
|---|---|---|---|---|
| S1 | E1 | QM | QM | QM |
| | E2 | QM | QM | QM |
| | E3 | QM | QM | level one |
| | E4 | QM | level one | level two |
| S2 | E1 | QM | QM | QM |
| | E2 | QM | QM | level one |
| | E3 | QM | level one | level two |
| | E4 | level one | level two | level three |
| S3 | E1 | QM | QM | level one |
| | E2 | QM | level one | level two |
| | E3 | level one | level two | level three |
| | E4 | level two | level three | level four |

What is claimed is:

1. An adaptive vehicle information processing method, comprising:
receiving a first vehicle information, identifying the function of the first vehicle information and analyzing all functional failures of the first vehicle information;
receiving a second vehicle information;
determining the relationship between all the above-mentioned functional failures and the second vehicle information corresponding to a preset safety threshold;
when the safety threshold is exceeded, setting up a severity of the hazardous event according to a predetermined standard, exposure rate and controllability level; and
according to the severity, exposure rate and controllability level of the hazard event, classifying a safety level of the first vehicle information.

2. The method according to claim 1, wherein the method further comprising:
checking the format of the first vehicle information, wherein when the format of the first vehicle information is not correct, and the error is still after rechecking is performed for a specified number of times, the first vehicle information is ignored.

3. The method according to claim 2, wherein the format of the first vehicle information is correct, the parsing of the first vehicle information includes normal information.

4. The method according to claim 2, wherein the format of the first vehicle information is correct, the parsing of the first vehicle information includes warning information

5. The method according to claim 1, wherein the second vehicle information includes at least one information other than the first vehicle information.

6. The method according to claim 1, wherein the severity of the described hazardous event includes: none; mild/moderate; severe; and fatal injury level.

7. The method according to claim 1, wherein the exposure rate of the hazardous event includes: ultra-low probability; low probability; medium probability; and high probability.

8. The method according to claim 1, wherein the controllability of the hazardous event includes: full controllability; simple controllability; regular controllability; and difficult controllability.

9. The method according to claim 1, wherein the safety level includes: from top to low, level one; level two; level three and level four.

10. The method according to claim 1, wherein when the safety level not exceeding the preset safety threshold, classify the first vehicle information the safety level.

11. An adaptive vehicle information processing system, comprising: a chip system for receiving a first vehicle information, identifying the function corresponding to the first vehicle information and analyzing all functional failures of the first vehicle information; receiving a second vehicle information; determine the relationship between all the above-mentioned functional failures and the second vehicle information corresponding to a preset safety threshold; when the safety threshold is exceeded, set up a severity of the hazardous event according to a predetermined standard, exposure rate and controllability level; and according to the severity, exposure rate and controllability level of the hazard event, to classify the safety level of the first vehicle information

12. The system according to claim 11, wherein the chip system further check the format of the first vehicle information, wherein when the format of the first vehicle information is not correct, and the error is still after rechecking is performed for a specified number of times, the first vehicle information is ignored.

13. The system according to claim 12, wherein when the format of the first vehicle information is correct, the chip system parses the first vehicle information including normal information.

14. The system according to claim 12, wherein when the format of the first vehicle information is correct, the chip system parses the first vehicle information including warning information.

15. The system according to claim 11, wherein the second vehicle information includes at least one information other than the first vehicle information.

16. The system according to claim 11, wherein the severity of the described hazardous event includes: none; mild/moderate; severe; and fatal injury level.

17. The system according to claim 11, wherein the exposure rate of the hazardous event includes: ultra-low probability; low probability; medium probability and high probability.

18. The system according to claim 11, wherein the controllability of the hazardous event includes: full controllability; simple controllability; regular controllability; and difficult controllability.

19. The system according to claim 11, wherein the safety level includes: from top to low, level one; level two; level three and level four.

20. The system according to claim 11, wherein when the safety level not exceeding the preset safety threshold, classify the first vehicle information the safety level.
